(19) United States
(12) Patent Application Publication
(10) Pub. No.: US 2025/0309993 A1
(43) Pub. Date: Oct. 2, 2025

(54) METHOD AND APPARATUS FOR WAVELENGTH CONTROL IN OPTICAL COMMUNICATION SYSTEM, AND COHERENT OPTICAL COMMUNICATION APPARATUS

(71) Applicant: InnoLight Technology (Suzhou) Ltd., Suzhou, Jiangsu (CN)

(72) Inventors: Gang Ling, Suzhou, Jiangsu (CN); Zhe XIA, Suzhou, Jiangsu (CN); YU-ZHOU SUN, Suzhou, Jiangsu (CN)

(21) Appl. No.: 19/237,802

(22) Filed: Jun. 13, 2025

Related U.S. Application Data
(63) Continuation of application No. PCT/CN2023/127113, filed on Oct. 27, 2023.

(30) Foreign Application Priority Data
Dec. 29, 2022 (CN) 202211709742.2

(51) Int. Cl. H04B 10/572; H01S 3/10; H04B 10/556

(52) U.S. Cl. CPC H04B 10/572; H01S 3/10015; H04B 10/5563

(57) ABSTRACT

A method and apparatus for wavelength control in an optical communication system, and a coherent optical communication apparatus. The method includes: setting an initial emission wavelength emitted by an emitting-end light source in an optical communication system; controlling a local oscillator light source at a receiving end in the optical communication system to emit a local oscillator wavelength; controlling a receiving end to receive the wavelength emitted by the emitting-end light source; and adjusting the wavelength emitted by the local oscillator light source in real time, such that the wavelength emitted by the local oscillator light source is consistent with the wavelength received by the receiving end.

### CROSS-REFERENCE TO RELATED PATENT APPLICATION

This application is a continuation application of International Patent Application Ser. No. PCT/CN2023/127113, filed on Oct. 27, 2023, and claims the priority of China Patent Application No. CN202211709742.2, filed on Dec. 29, 2022 in People's Republic of China. The entirety of each of the above patent applications is hereby incorporated by reference and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present application relates to the field of optical communication technology, and more particularly relates to a method and apparatus for wavelength control, storage medium, computer program product, and coherent optical communication apparatus in an optical communication system.

### BACKGROUND OF THE DISCLOSURE

With the development of coherent modules, high-speed gray light modules in data centers have begun to adopt coherent technology. The use of coherent technology has the advantages of high sensitivity, large communication capacity, and high bit rate.

However, the output wavelength of the laser of the gray light module is easily affected by operating temperature, operating current, and working life, etc., and frequency deviation is inevitable. The coherent technology module requires the wavelengths of the received light and the local oscillator light source to be highly consistent. Therefore, the wavelength control of the light source is crucial in the coherent technology.

Wavelength control generally uses a wavelength locking solution, but this solution has the disadvantages of being large in size, high in cost, and unable to be used in plurality in miniaturized high-density modules. Therefore, in order to achieve high integration, a highly integrated optical module is urgently needed.

### SUMMARY OF THE DISCLOSURE

Accordingly, it is necessary to provide a method and apparatus for wavelength control, a computer device, a computer-readable storage medium, a computer program product, and a coherent optical communication apparatus in an optical communication system for achieving high integration in order to solve the above technical problems.

In a first aspect, the present application provides a method for wavelength control in an optical communication system. The method includes the following processes.

An initial emission wavelength emitted by an emitting-end light source in the optical communication system is set.

A local oscillator light source at a receiving end in the optical communication system is controlled to emit a local oscillator wavelength.

The receiving end is controlled to receive the wavelength emitted by the emitting-end light source.

The wavelength emitted by the local oscillator light source is adjusted in real time, so that the wavelength emitted by the local oscillator light source is consistent with the wavelength received by the receiving end.

In one embodiment, before controlling the local oscillator light source at the receiving end in the optical communication system to emit the local oscillator wavelength, the method includes the following processes.

An initial local oscillator wavelength emitted by the local oscillator light source at the receiving end in the optical communication system is set, so that the initial local oscillator wavelength is set to be the same as the initial emission wavelength.

In one embodiment, the process of setting the initial emission wavelength emitted by the emitting-end light source of the optical communication system includes the following processes.

An expected wavelength that is set at an emitting end and an emitting-end light source lookup table are obtained.

Light source parameters that are required are determined according to the expected wavelength that is set and the emitting-end light source lookup table.

The emitting-end light source is adjusted according to the determined light source parameters so that the initial emission wavelength emitted by the emitting-end light source is the same as the expected wavelength that is set.

In one embodiment, the process of controlling the local oscillator light source at the receiving end in the optical communication system to emit the local oscillator wavelength includes the following processes.

Parameters of the local oscillator light source at the receiving end are scanned to obtain a local oscillator light source lookup table.

The local oscillator light source is controlled to emit the local oscillator wavelength.

In one embodiment, the process of obtaining the emitting-end light source lookup table includes the following processes.

M emitting-end light source temperature monitoring points are set, and an emitting-end light source temperature controller is adjusted according to the temperature monitoring points so that the emitting-end light source is kept at a target temperature.

At each of the emitting-end light source temperature monitoring points, an emitting reference wavelength of the emitting-end light source is obtained.

An emitting-end light source lookup table is created according to the correspondence between the M emitting-end light source temperature monitoring points and the emitting reference wavelength.

In one embodiment, the process of obtaining the local oscillator light source lookup table includes the following processes.

M local oscillator light source temperature monitoring points are set, and a local oscillator light source temperature controller is adjusted according to the temperature monitoring points so that the local oscillator light source is kept at a target temperature.

At each of the local oscillator light source temperature monitoring points, a local oscillator reference wavelength of the local oscillator light source is obtained.

The local oscillator light source lookup table is created according to the correspondence between the M local oscillator light source temperature monitoring points and the local oscillator reference wavelength.

In one embodiment, the process of obtaining the emitting-end light source lookup table includes the following processes.

M emitting-end light source temperature monitoring points are set, and an emitting-end light source temperature controller is adjusted according to the temperature monitoring points so that the emitting-end light source is kept at a target temperature.

At each of the emitting-end light source temperature monitoring points, N emitting-end light source operating currents are set.

At each of the emitting-end light source operating currents, an emitting reference output optical power and an emitting reference wavelength of the emitting-end light source are obtained.

An emitting-end light source lookup table is created according to the correspondence between the M emitting-end light source temperature monitoring points, the N emitting-end light source operating currents, and the emitting reference output optical power and the emitting reference wavelength of the emitting-end light source.

In one embodiment, the process of obtaining the local oscillator light source lookup table includes the following processes.

The M local oscillator light source temperature monitoring points are set, and the local oscillator light source temperature controller is adjusted according to the temperature monitoring points so that the local oscillator light source is kept at a target temperature.

At each of the local oscillator light source temperature monitoring points, N local oscillator light source operating currents are set.

At each of the local oscillator light source operating currents, a local oscillator reference output optical power and the local oscillator reference wavelength of the local oscillator light source are obtained.

The local oscillator light source lookup table is created according to the correspondence between the M local oscillator light source temperature monitoring points, the N local oscillator light source operating currents, the local oscillator reference output optical power, and the local oscillator reference wavelength.

In one embodiment, the process of setting the initial local oscillator wavelength emitted by the local oscillator light source at the receiving end in the optical communication system, so that the initial local oscillator wavelength is set to be the same as the initial emission wavelength, includes the following processes.

The initial emission wavelength of the emitting-end light source is obtained.

An expected local oscillator wavelength of the local oscillator light source is obtained according to the initial emission wavelength.

According to the expected local oscillator wavelength, a local oscillator light source lookup table is searched to obtain an initial local oscillator light source temperature monitoring point.

A local oscillator light source temperature monitoring point is set as the initial local oscillator light source temperature monitoring point.

In one embodiment, the process of adjusting the local oscillator wavelength in real time, such that the wavelength emitted by the local oscillator light source is consistent with the wavelength received by the receiving end, includes the following processes.

The wavelength received by the receiving end is obtained, and the wavelength received by the receiving end are compared with the local oscillator wavelength.

When the local oscillator wavelength is greater than the wavelength received by the receiving end, the temperature of the local oscillator light source is reduced.

When the local oscillator wavelength is smaller than the wavelength received by the receiving end, the temperature of the local oscillator light source is increased.

In a second aspect, the present application provides an apparatus for wavelength control in an optical communication system. The apparatus includes the following components.

An emitting-end light source setting module is used to set an initial emission wavelength emitted by the emitting-end light source in the optical communication system.

A local oscillator light source control module is used to control the local oscillator light source at a receiving end in the optical communication system to emit a local oscillator wavelength.

A receiving-end control module is used to control the receiving end to receive the wavelength emitted by the emitting-end light source.

A wavelength adjustment module is used to adjust the wavelength emitted by the local oscillator light source in real time, so that the wavelength emitted by the local oscillator light source is consistent with the wavelength received by the receiving end.

In a third aspect, the present application provides a computer-readable storage medium. The computer-readable storage medium has a computer program stored thereon, and the computer program implements the following processes when executed by a processor.

An initial emission wavelength emitted by an emitting-end light source in the optical communication system is set.

A local oscillator light source at a receiving end in the optical communication system is controlled to emit a local oscillator wavelength.

The receiving end is controlled to receive the wavelength emitted by the emitting-end light source.

The wavelength emitted by the local oscillator light source is adjusted in real time, so that the wavelength emitted by the local oscillator light source is consistent with the wavelength received by the receiving end.

In a fourth aspect, the present application provides a computer program product. The computer program product includes a computer program. When the computer program is executed by a processor, the following processes are implemented.

An initial emission wavelength emitted by an emitting-end light source in the optical communication system is set.

A local oscillator light source at a receiving end in the optical communication system is controlled to emit a local oscillator wavelength.

The receiving end is controlled to receive the wavelength emitted by the emitting-end light source.

The wavelength emitted by the local oscillator light source is adjusted in real time, so that the wavelength emitted by the local oscillator light source is consistent with the wavelength received by the receiving end.

In a fifth aspect, the present application provides a coherent optical communication apparatus. The coherent optical communication apparatus includes the following components.

An emitting-end light source module is used to emit emission light.

A local oscillator light source module is used to emit local oscillator light.

A data processing module includes a data processing unit used to modulate an electrical signal and output the modulated electrical signal to a photonic integrated circuit and/or process an electrical signal to be demodulated received from the photonic integrated circuit. The data processing module further includes the apparatus for wavelength control in the optical communication system according to the second aspect that is used to implement a method for wavelength control.

The photonic integrated circuit is used for receiving the modulated electrical signal from the data processing module or outputting the electrical signal to be demodulated to a data processing apparatus. The photonic integrated circuit includes a coherent modulator used to modulate the emission light through the modulated electrical signal to form an emission light signal, and emit the emission light signal from an emitting end. The photonic integrated circuit further includes a coherent receiver used to receive an optical signal from the receiving end and convert the optical signal into an electrical signal.

In the method and the apparatus for wavelength control, the computer device, the computer-readable storage medium, the computer program product, and the coherent optical communication apparatus in the optical communication system, through setting the initial emission wavelength emitted by the emitting-end light source in the optical communication system; controlling the local oscillator light source at the receiving end in the optical communication system to emit the local oscillator wavelength; controlling the receiving end to receive the wavelength emitted by the emitting-end light source; and adjusting the wavelength emitted by the local oscillator light source in real time, so that the wavelength emitted by the local oscillator light source is consistent with the wavelength received by the receiving end, the signal of the received wavelength can be demodulated in the present disclosure. Since the technical solutions of the present disclosure sets the initial emission wavelength and the local oscillator wavelength, when the communication between modules is initially established, the wavelength or the frequency of a light-wave is within a controllable range. Furthermore, the wavelength emitted by the local oscillator light source is adjusted in real time, so that the wavelength emitted by the local oscillator light source is consistent with the wavelength received by the receiving end, thereby allowing the signal to be demodulated, reducing the use of additional components, and making apparatuses of the present disclosure small in size, able to achieve high integration, thus reducing costs.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic flowchart of a method for wavelength control in an optical communication system according to one embodiment;

FIG. 2 is a schematic flowchart showing steps of setting an initial emission wavelength emitted by an emitting-end light source in the optical communication system according to one embodiment;

FIG. 3 is a schematic flowchart showing steps for controlling a local oscillator light source at a receiving end of the optical communication system to emit a local oscillator wavelength according to one embodiment;

FIG. 4 is a schematic flowchart of processes for obtaining an emitting-end light source lookup table according to one embodiment;

FIG. 5 is a schematic flowchart of processes for obtaining a local oscillator light source lookup table according to one embodiment;

FIG. 6 is a schematic flowchart of processes for obtaining the emitting-end light source lookup table according to another embodiment;

FIG. 7 is a schematic flowchart of processes for obtaining the local oscillator light source lookup table according to another embodiment;

FIG. 8 is a flowchart showing steps of setting an initial local oscillator wavelength emitted by the local oscillator light source at the receiving end of the optical communication system and setting the initial local oscillator wavelength to be the same as the initial emission wavelength according to yet another embodiment;

FIG. 9 is a flowchart showing steps of adjusting the local oscillator wavelength in real time so that a wavelength emitted by the local oscillator light source is consistent with a wavelength received by the receiving end according to another embodiment;

FIG. 10 is another schematic flowchart of the method for wavelength control in the optical communication system according to one embodiment;

FIG. 11 is a block diagram of an apparatus for wavelength control in the optical communication system according to one embodiment;

FIG. 12 is a schematic diagram showing an internal structure of a computer apparatus according to one embodiment;

FIG. 13 is a schematic diagram of the structure of a coherent optical communication apparatus according to one embodiment;

FIG. 14 is a schematic diagram of the structure of two of the coherent optical communication apparatus transmitting with each other according to one embodiment.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to more clearly describe the purpose, technical solution, and advantages of the present application, the present application is further described in detail below in conjunction with the accompanying drawings and embodiments. It should be understood that the specific embodiments described herein are only used to explain the present application and are not used to limit the present application.

The method for wavelength control provided in the embodiment of the present disclosure can be applied to a coherent module. It can be understood that the coherent module is a module in a communication link, and multiple coherent modules of the present disclosure can be disposed in the communication link. The coherent module can be an uplink coherent module or a downlink coherent module. For ease of understanding, in some embodiments, the present disclosure describes the method provided by the present disclosure when the coherent module is a downlink coherent module. However, it can be understood that the coherent module of the present disclosure can also be used as an uplink coherent module.

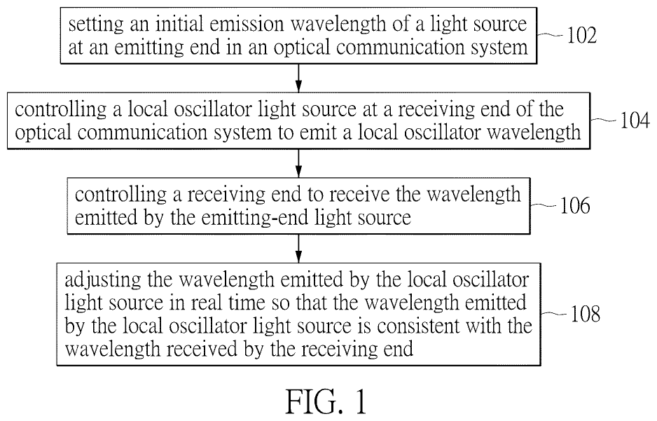

In one embodiment, as shown in FIG. 1, a method for wavelength control in an optical communication system is provided. The method for wavelength control includes the following processes:
step 102, which includes setting an initial emission wavelength of alight source at an emitting end in an optical communication system.

Here, an emitting-end light source and a local oscillator light source may be laser light sources, and specifically, may be distributed feedback (DFB) lasers.

Optionally, the initial emission wavelength of the emitting-end light source may be set to a fixed value. Furthermore, the initial emission wavelength may be optionally set to any one of 850 nm, 1310 nm, or 1550 nm.

The purpose of selecting one of the above three wavelengths is to comprehensively consider the optical fiber loss and scattering, with the purpose of transmitting the most data through the longest distance with the minimum optical fiber loss, and the three wavelengths have almost zero absorption and are most suitable as wavelengths for transmission in optical fibers. Furthermore, the initial emission wavelength can optionally be set to 1310 nm.
Step 104 includes controlling a local oscillator light source at a receiving end of the optical communication system to emit a local oscillator wavelength.
Step 106 includes controlling a receiving end to receive the wavelength emitted by the emitting-end light source.

It can be understood that when the coherent module is a downlink coherent module, a controller of an uplink coherent module controls the emitting-end light source to emit the emission wavelength, which is then received by a receiving-end module controlled by a controller of the downlink coherent module to obtain a received wavelength; at the same time, the controller of the downlink coherent module controls the local oscillator light source to emit a local oscillator wavelength.
Step 108 includes adjusting the wavelength emitted by the local oscillator light source in real time so that the wavelength emitted by the local oscillator light source is consistent with the wavelength received by the receiving end.

As the working time and ambient temperature change, the wavelength of an uplink emitting-end light source and the wavelength of a downlink local oscillator light source will inevitably drift, and the drift amounts are inconsistent, such that adjusting the wavelength of the downlink local oscillator light source in real time is needed.

Optionally, by comparing the received wavelength with the local oscillator wavelength and adjusting the local oscillator wavelength in real time, long-term consistency can be maintained between a downlink local oscillator wavelength and an uplink emitting wavelength under various working conditions, thereby achieving wavelength locking control.

In the abovementioned method for wavelength control, a DFB laser light source is directly used without an additional frequency stabilization module, such that the overall volume is small, the degree of integration is high, and the cost is low. Since the emitting-end light source and the local oscillator light source use two lasers, the output wavelength is not very stable. Therefore, by not adjusting the wavelength of the emitting-end light source, only the wavelength emitted by the local oscillator light source is adjusted in real time. In this way, the wavelength emitted by the local oscillator light source is consistent with the wavelength received by the receiving end, and the local oscillator wavelength is consistent with the wavelength received by the receiving end, such that the subsequent signal extraction is more accurate.

In one embodiment, before controlling the local oscillator light source at the receiving end of the optical communication system to emit a local oscillator wavelength, the method includes: setting an initial local oscillator wavelength emitted by the local oscillator light source at the receiving end of the optical communication system, and setting the initial local oscillator wavelength to be the same as the initial emission wavelength. Those skilled in the art can understand that maintaining the local oscillator wavelength to be consistent with the received wavelength indicates that the wavelengths tend to be consistent.

Setting the initial local oscillator wavelength emitted by the local oscillator light source at the receiving end of the optical communication system to be the same as the initial emission wavelength can ensure that the initial wavelength deviation is not large when the coherent module is started, such that normal coherent communication can be quickly established.

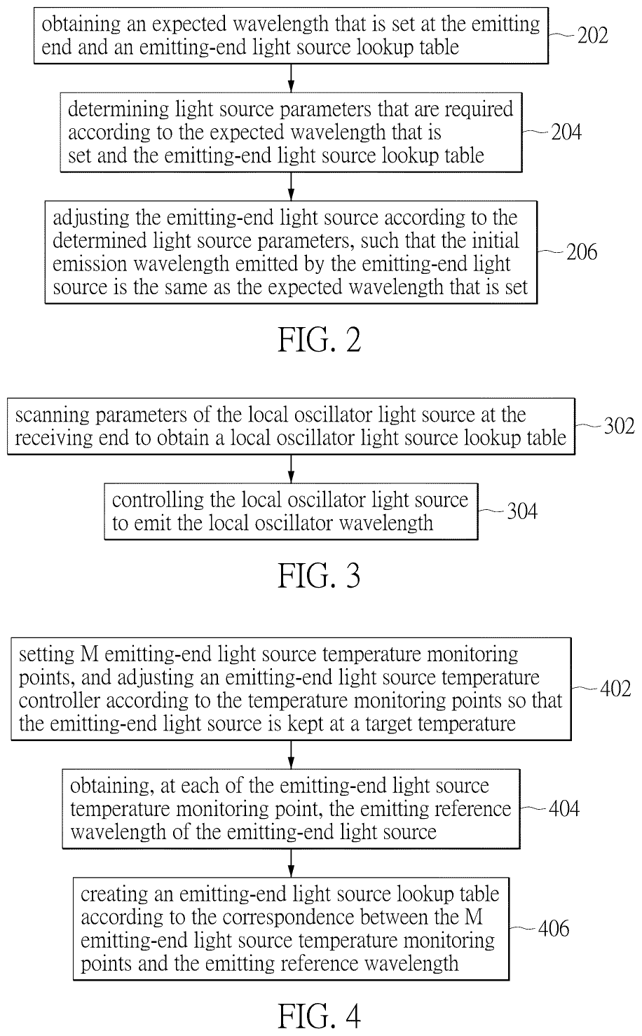

In one embodiment, as shown in FIG. 2, in step 102, the step of setting the initial emission wavelength emitted by the emitting-end light source in the optical communication system includes:
step 202, which includes obtaining an expected wavelength that is set at the emitting end and an emitting-end light source lookup table.

Specifically, an expected emission wavelength of the emitting-end light source may be a preset wavelength. Optionally, the wavelength may be 1310 nm. Furthermore, the emitting-end light source lookup table stored in a memory is read.
Step 204 includes determining light source parameters that are required according to the expected wavelength that is set and the emitting-end light source lookup table.

Specifically, the light source parameter of the emitting-end light source corresponding to the wavelength expected to be output by the emitting-end light source can be found by reading the emitting-end light source lookup table stored in the memory. Optionally, the parameter is a temperature monitoring point.
Step 206 includes adjusting the emitting-end light source according to the determined light source parameters, such that the initial emission wavelength emitted by the emitting-end light source is the same as the expected wavelength that is set.

Specifically, an emitting-end light source temperature controller is controlled to adjust the temperature of the emitting-end light source to an emitting-end light source temperature monitoring point corresponding to the wavelength expected to be output by the emitting-end light source, such that the emitting-end light source can output an expected output wavelength.

In one embodiment, as shown in FIG. 3, in step 104, the step of controlling the local oscillator light source at the receiving end of the optical communication system to emit a local oscillator wavelength includes:
step 302, which includes scanning parameters of the local oscillator light source at the receiving end to obtain a local oscillator light source lookup table.

Optionally, the local oscillator wavelength to be emitted may be obtained by scanning the parameters of the local oscillator light source at the receiving end and reading the local oscillator light source lookup table stored in the memory.
Step 304 includes controlling the local oscillator light source to emit the local oscillator wavelength.

Optionally, the relevant parameters of the light source are adjusted by changing the temperature of the light source or changing an applied current, such that the local oscillator light source emits the local oscillator wavelength that is set.

The wavelength of the emitting-end light source and the wavelength of the local oscillator light source are related to the temperature of the light source, the circuit loaded on the light source, and the structure of the light source itself. In order to obtain the set or required wavelength, the wavelength output by the light source can be adjusted by adjusting the temperature, current, etc. of the light source. The temperature or the current can be exclusively adjusted, or the temperature and the current can be adjusted at the same time. In this example, the current is mainly adjusted by adjusting the temperature. In other embodiments, the temperature and the current can be adjusted at the same time, or only the current is adjusted.

In addition, in order to quickly adjust the wavelength of the emitting-end light source and the local oscillator light source to a set value, the required temperature and/or current can be obtained by reading the emitting-end light source lookup table and the local oscillator light source lookup table that are pre-calibrated in the memory. In this way, the emitting-end light source and the local oscillator light source can quickly reach the required temperature and/or current and achieve the output of the required wavelength.

In one embodiment, as shown in FIG. 4, the process of obtaining the emitting-end light source lookup table in step 202 includes:
step 402, which includes setting M emitting-end light source temperature monitoring points, and adjusting an emitting-end light source temperature controller according to the temperature monitoring points so that the emitting-end light source is kept at a target temperature.

Specifically, an emitting-end light source operating current is fixed, the temperature of the emitting-end light source is controlled by adjusting the emitting-end light source temperature controller, and the M emitting-end light source temperature monitoring points are set as follows, such that the emitting-end light source is kept at a target temperature: TX Thermal Monitor_1, TX Thermal Monitor_2, . . . , TX Thermal Monitor_i, . . . , TX Thermal Monitor_M, in which i≤M. Optionally, the temperature values of the M emitting-end light source temperature monitoring points can be obtained from an emitting-end light source temperature monitor.
Step 404 includes obtaining, at each of the emitting-end light source temperature monitoring point, the emitting reference wavelength of the emitting-end light source.

Specifically, when the emitting-end light source temperature monitoring point is set to TX Thermal Monitor_1, the obtained emitting reference wavelength of the emitting-end light source is TX WaveLen_1; when the emitting-end light source temperature monitoring point is set to TX Thermal Monitor_2, the obtained emitting reference wavelength of the emitting-end light source is TX WaveLen_2. Similarly, when the emitting-end light source temperature monitoring point is set to TX Thermal Monitor_M, the obtained emitting reference wavelength of the emitting-end light source is TX WaveLen_M. Therefore, the emitting reference wavelengths of the emitting-end light source at different emitting-end light source temperature monitoring points are scanned, and then the emitting-end light source lookup table is obtained.
Step 406 includes creating an emitting-end light source lookup table according to the correspondence between the M emitting-end light source temperature monitoring points and the emitting reference wavelength.

In certain embodiments, the above-mentioned emitting-end light source lookup table may be as shown in Table 1.

TABLE 1

| Emitting-end light source | Emitting reference |
|---|---|
| temperature monitoring point | wavelength |
| TX Thermal Monitor_1 | TX WaveLen_1 |
| TX Thermal Monitor_2 | TX WaveLen_2 |
| TX Thermal Monitor_3 | TX WaveLen_3 |
| . . . | . . . |
| TX Thermal Monitor_i | TX WaveLen_i |
| . . . | . . . |
| TX Thermal Monitor_M | TX WaveLen_M |

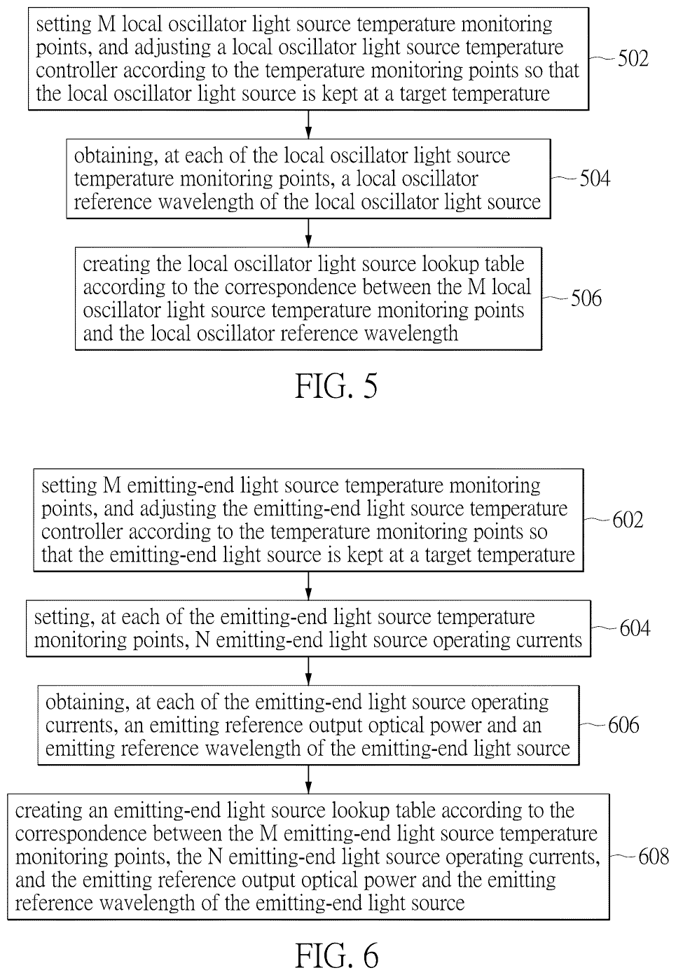

In one embodiment, as shown in FIG. 5, the process of obtaining the local oscillator light source lookup table in step 302 includes:
step 502, which includes setting M local oscillator light source temperature monitoring points, and adjusting a local oscillator light source temperature controller according to the temperature monitoring points so that the local oscillator light source is kept at a target temperature.
Step 504 includes obtaining, at each of the local oscillator light source temperature monitoring points, a local oscillator reference wavelength of the local oscillator light source.
Step 506 includes creating the local oscillator light source lookup table according to the correspondence between the M local oscillator light source temperature monitoring points and the local oscillator reference wavelength.

The process of obtaining the local oscillator light source lookup table is similar to the process of obtaining the emitting-end light source lookup table in FIG. 4, so similar descriptions are not reiterated herein.

In certain embodiments, the local oscillator light source lookup table may be as shown in Table 2.

TABLE 2

| Local oscillator light source | LO reference |
|---|---|
| temperature monitoring point | wavelength |
| LO Thermal Monitor_1 | LO WaveLen_1 |
| LO Thermal Monitor_2 | LO WaveLen_2 |
| LO Thermal Monitor_3 | LO WaveLen_3 |
| . . . | . . . |
| LO Thermal Monitor_i | LO WaveLen_i |
| . . . | . . . |
| LO Thermal Monitor_M | LO WaveLen_M |

It can be understood that the lookup table data of the emitting-end light source and the local oscillator light source will be different due to the differences in the light sources used. Furthermore, although only part of the data is listed here, the actual data of the lookup table will be more in number to ensure accuracy. As the temperature rises, the wavelength emitted by the light source will become longer. Therefore, in this embodiment, by adjusting the emitting-end light source temperature controller or the local oscillator light source temperature controller to adjust the temperature of the emitting-end light source or the local oscillator light source, an emitting-end wavelength and the local oscillator wavelength can be indirectly adjusted. By establishing a one-to-one lookup table for temperature and wavelength, the wavelength required for communication can be quickly located when initially establishing communication. Furthermore, by setting the temperature monitoring points to increase in sequence, the lookup table is more convenient for searching the temperature and the corresponding wavelength.

Furthermore, the wavelength of the light source is affected by temperature and also affected by the operating current. Under the same temperature, the greater the operating current is, the longer the wavelength is. However, the increase in operating current will be accompanied by an increase in a light source output optical power, and the increase in temperature will be accompanied by a decrease in the light source output optical power. That is, the wavelength of the light source is positively correlated with both temperature and operating current; the light source output optical power is positively correlated with the operating current and negatively correlated with temperature. Changes in operating current have a greater impact on the light source output optical power, and changes in temperature have a greater impact on the wavelength of the light source. Changes in the light source output optical power will affect the overall performance of coherent transmission. Therefore, when initially setting the light source, the two parameters of the light source wavelength and the light source output optical power need to be comprehensively considered. At the same time, the stability of the light source wavelength and the light source output optical power is maintained to improve the implementation process.

Therefore, in one embodiment, the light source wavelength and the light source output optical power are obtained for different emitting-end light source temperature monitoring points and different operating currents. As shown in FIG. 6, the process of obtaining the emitting-end light source lookup table in step 202 includes:
step 602, which includes setting M emitting-end light source temperature monitoring points, and adjusting the emitting-end light source temperature controller according to the temperature monitoring points so that the emitting-end light source is kept at a target temperature.

Specifically, the temperature of the emitting-end light source is controlled by adjusting the emitting-end light source temperature controller, and M emitting-end light source temperature monitoring points are set as follows, such that the emitting-end light source is kept at a target temperature: TX Thermal Monitor_1, TX Thermal Monitor 2, . . . , TX Thermal Monitor_i, . . . , TX Thermal Monitor_M, in which i≤M. Optionally, the temperature values of the M emitting-end light source temperature monitoring points can be obtained from the emitting-end light source temperature monitor.
Step 604 includes setting, at each of the emitting-end light source temperature monitoring points, N emitting-end light source operating currents.

Specifically, when the emitting-end light source temperature monitoring point is set to TX Thermal Monitor_1, the emitting-end light source operating current is controlled, and N emitting-end light source operating currents are set: TX Laser Current_1, TX Laser Current_2, . . . , TX Laser Currentj, . . . , TX Laser Current_N, in which j≤N. Optionally, the operating currents of the N emitting-end light sources can be obtained from an electric control box of the emitting-end light source.
Step 606 includes obtaining, at each of the emitting-end light source operating currents, an emitting reference output optical power and an emitting reference wavelength of the emitting-end light source.

Specifically, when the emitting-end light source temperature monitoring point is set to TX Thermal Monitor_1 and the emitting-end light source operating current is TX Laser Current_1, the obtained emitting reference output optical power of the emitting-end light source is TX Power_11, and the obtained emitting reference wavelength of the emitting-end light source is TX WaveLen_11; when the emitting-end light source temperature monitoring point is set to TX Thermal Monitor_1 and the emitting-end light source operating current is TX Laser Current_2, the obtained emitting reference output optical power of the emitting-end light source is TX Power_12, and the obtained emitting reference wavelength of the emitting-end light source is TX WaveLen_12. Similarly, when the emitting-end light source temperature monitoring point is set to TX Thermal Monitor_1 and the emitting-end light source operating current is TX Laser Current_N, the obtained emitting reference output optical power of the emitting-end light source is TX Power_1N, and the obtained emitting reference wavelength of the emitting-end light source is TX WaveLen_1N.

When the emitting-end light source temperature monitoring point is set to TX Thermal Monitor_2 and the emitting-end light source operating current is TX Laser Current_1, the obtained emitting reference output optical power of the emitting-end light source is TX Power_21, and the obtained emitting reference wavelength of the emitting-end light source is TX WaveLen_21; when the emitting-end light source temperature monitoring point is set to TX Thermal Monitor_2 and the emitting-end light source operating current is TX Laser Current_2, the obtained emitting reference output optical power of the emitting-end light source is TX Power_22, and the obtained emitting reference wavelength of the emitting-end light source is TX WaveLen_22. Similarly, when the emitting-end light source temperature monitoring point is set to TX Thermal Monitor_2 and the emitting-end light source operating current is TX Laser Current_N, the obtained emitting reference output optical power of the emitting-end light source is TX Power_2N, and the obtained emitting reference wavelength of the emitting-end light source is TX WaveLen_2N.

Accordingly, it can be understood that, when the emitting-end light source temperature monitoring point is set to TX Thermal Monitor_M and the emitting-end light source operating current is TX Laser Current_1, the obtained emitting reference output optical power of the emitting-end light source is TX Power_M1, and the obtained emitting reference wavelength of the emitting-end light source is TX WaveLen_M1; when the emitting-end light source temperature monitoring point is set to TX Thermal Monitor_M and the emitting-end light source operating current is TX Laser Current_2, the obtained emitting reference output optical power of the emitting-end light source is TX Power_M2, and the obtained emitting reference wavelength of the emitting-end light source is TX WaveLen_M2. Accordingly, when the emitting-end light source temperature monitoring point is set to TX Thermal Monitor_M and the emitting-end light source operating current is TX Laser Current_N, the obtained emitting reference output optical power of the emitting-end light source is TX Power_MN, and the obtained emitting reference wavelength of the emitting-end light source is TX WaveLen_MN.

Therefore, the emitting reference output optical power and emitting reference wavelength of the emitting-end light source at different emitting-end light source temperature monitoring points and different operating currents of the emitting-end light source can be scanned, and then the emitting-end light source lookup table can be obtained.
Step 608 includes creating an emitting-end light source lookup table according to the correspondence between the M emitting-end light source temperature monitoring points, the N emitting-end light source operating currents, and the emitting reference output optical power and the emitting reference wavelength of the emitting-end light source.

In certain embodiments, the above-mentioned emitting-end light source lookup table can be as shown in Table 3.

TABLE 3

| | TX Laser | TX Laser | TX Laser | | TX Laser | | TX Laser |
|---|---|---|---|---|---|---|---|
| | Current_1 | Current_2 | Current_3 | . . . | Current_j | . . . | Current_N |
| TX Thermal | TX | TX | TX | . . . | TX | . . . | TX |
| Monitor_1 | Power_11 | Power_12 | Power_13 | | Power_1j | | Power_1N |
| | TX | TX | TX | . . . | TX | . . . | TX |
| | WaveLen_11 | WaveLen_12 | WaveLen_13 | | WaveLen_1j | | WaveLen_1N |
| TX Thermal | TX | TX | TX | . . . | TX | . . . | TX |
| Monitor_2 | Power_21 | Power_22 | Power_23 | | Power_2j | | Power_2N |
| | TX | TX | TX | . . . | TX | . . | TX |
| | WaveLen_21 | WaveLen_22 | WaveLen_23 | | WaveLen_2j | | WaveLen_2N |
| TX Thermal | TX | TX | TX | . . . | TX | . . . | TX |
| Monitor_3 | Power_31 | Power_32 | Power_33 | | Power_3j | | Power_3N |
| | TX | TX | TX | . . . | TX | . . . | TX |
| | WaveLen_31 | WaveLen_32 | WaveLen_33 | | WaveLen_3j | | WaveLen_3N |
| . . . | . . . | . . . | . . . | . . . | . . . | . . . | . . . |
| TX Thermal | TX | TX | TX | . . . | TX | . . . | TX |
| Monitor_i | Power_i1 | Power_i2 | Power_i3 | | Power_ij | | Power_iN |
| | TX | TX | TX | . . . | TX | . . . | TX |
| | WaveLen_i1 | WaveLen_i2 | WaveLen_i3 | | WaveLen_3j | | WaveLen_iN |
| . . . | . . . | . . . | . . . | . . . | . . . | . . . | . . . |
| TX Thermal | TX | TX | TX | . . . | TX | . . . | TX |
| Monitor_M | Power_M1 | Power_M2 | Power_M3 | | Power_Mj | | Power_MN |
| | TX | TX | TX | . . . | TX | . . . | TX |
| | WaveLen_M1 | WaveLen_M2 | WaveLen_M3 | | WaveLen_Mj | | WaveLen_MN |

Optionally, TX Thermal Monitor_1 to TX Thermal Monitor_M are increased in sequence, and TX Laser Current_1 to TX Laser Current_N are increased in sequence. Therefore, under the same emitting-end light source operating current, TX WaveLen_1j to TX WaveLen_Mj (j=1, 2, 3, . . . , N) are increased in sequence, and TX Power_1j to TX Power_Mj (j=0, 1, 2, 3, . . . ) decreases in sequence; at the same emitting-end light source temperature monitoring point, TX WaveLen_i1 to TX WaveLen_iN (i=1, 2, 3, . . . , M) are increased in sequence, and TX Power_i1 to TX Power_iN (i=1, 2, 3, . . . , M) are increased in sequence.

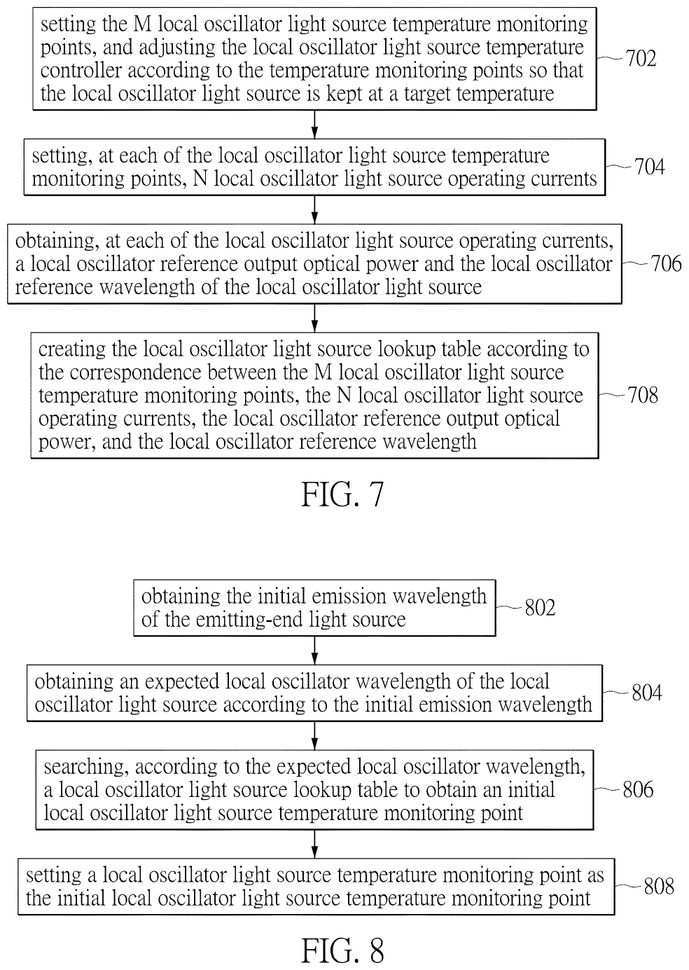

In one embodiment, the light source wavelength and the light source output optical power are obtained for different local oscillator light source temperature monitoring points and different operating currents. As shown in FIG. 7, in step 302, the process of obtaining the local oscillator light source lookup table includes the following steps.
Step 702 includes setting the M local oscillator light source temperature monitoring points, and adjusting the local oscillator light source temperature controller according to the temperature monitoring points so that the local oscillator light source is kept at a target temperature.
Step 704 includes setting, at each of the local oscillator light source temperature monitoring points, N local oscillator light source operating currents.
Step 706 includes obtaining, at each of the local oscillator light source operating currents, a local oscillator reference output optical power and the local oscillator reference wavelength of the local oscillator light source.
Step 708 includes creating the local oscillator light source lookup table according to the correspondence between the M local oscillator light source temperature monitoring points, the N local oscillator light source operating currents, the local oscillator reference output optical power, and the local oscillator reference wavelength.

The process of obtaining the local oscillator light source lookup table is similar to the process of obtaining the emitting-end light source lookup table in FIG. 6, therefore, similar descriptions will not be reiterated herein.

In certain embodiments, the local oscillator light source lookup table may be as shown in Table 4.

TABLE 4

| | LO Laser | LO Laser | LO Laser | | LO Laser | | LO Laser |
|---|---|---|---|---|---|---|---|
| | Current_1 | Current_2 | Current_3 | . . . | Current_j | . . . | Current_N |
| LO Thermal | LO | LO | LO | . . . | LO | . . . | LO |
| Monitor_1 | Power_11 | Power_12 | Power_13 | | Power_1j | | Power_1N |
| | LO | LO | LO | . . . | LO | . . . | LO |
| | WaveLen_11 | WaveLen_12 | WaveLen_13 | | WaveLen_1j | | WaveLen_1N |
| LO Thermal | LO | LO | LO | . . . | LO | . . . | LO |
| Monitor_2 | Power_21 | Power_22 | Power_23 | | Power_2j | | Power_2N |
| | LO | LO | LO | . . . | LO | . . . | LO |
| | WaveLen_21 | WaveLen_22 | WaveLen_23 | | WaveLen_2j | | WaveLen_2N |
| LO Thermal | LO | LO | LO | . . . | LO | . . . | LO |
| Monitor_3 | Power_31 | Power_32 | Power_33 | | Power_3j | | Power_3N |
| | LO | LO | LO | . . . | LO | . . . | LO |
| | WaveLen_31 | WaveLen_32 | WaveLen_33 | | WaveLen_3j | | WaveLen_3N |
| . . . | . . . | . . . | . . . | . . . | . . . | . . . | . . . |
| LO Thermal | LO | LO | LO | . . . | LO | . . . | LO |
| Monitor_i | Power_i1 | Power_i2 | Power_i3 | | Power_ij | | Power_iN |
| | LO | LO | LO | . . . | LO | . . . | LO |
| | WaveLen_i1 | WaveLen_i2 | WaveLen_i3 | | WaveLen_ij | | WaveLen_iN |
| . . . | . . . | . . . | . . . | . . . | . . . | . . . | . . . |
| LO Thermal | LO | LO | LO | . . . | LO | . . . | LO |
| Monitor_M | Power_M1 | Power_M2 | Power_M3 | | Power_Mj | | Power_MN |
| | LO | LO | LO | . . . | IT | . . . | IT |
| | WaveLen_M1 | WaveLen_M2 | WaveLen_M3 | | WaveLen_M | | WaveLen_MN |

Optionally, LO Thermal Monitor_1 to LO Thermal Monitor_M are increased in sequence, and LO Laser Current_1I to LO Laser Current_N are increased in sequence. Accordingly, at the same local oscillator light source operating current, LO WaveLen_1j to LO WaveLen_Mj (j=1, 2, 3, . . . , N) are increased in sequence, and LO Power_1j to LO Power_Mj (j=0, 1, 2, 3, . . . ) are decreased in sequence; at the same local oscillator light source temperature monitoring point, LO WaveLen_i1 to LO WaveLen_iN (i=1, 2, 3, . . . , M) are increased in sequence, and LO Power_i1 to LO Power_iN (i=1, 2, 3, . . . , M) are increased in sequence.

It can be understood that data in the lookup table of the emitting-end light source and the local oscillator light source will be different due to the differences in the light sources adopted. Also, although only part of the data is listed here, the actual data of the lookup table will be more in number to ensure accuracy.

In certain embodiments, the emitting-end light source temperature monitoring point and the local oscillator light source temperature monitoring point can be set to the same temperature monitoring point; the emitting-end light source operating current and the local oscillator light source operating current can be set to the same operating current.

Since the wavelength of the light source is affected by both the temperature and the operating current, a lookup table of temperature, operating current, and wavelength is formulated for both the emitting-end light source and the local oscillator light source. Since the change of the operating current will also affect the light source output optical power, and the change of the light source output optical power will affect the overall performance of coherent transmission, therefore, when the emitting-end light source and the local oscillator light source are initially set, it is necessary to comprehensively consider the parameters of the light source wavelength and the light source output optical power. The temperature of the emitting-end light source or the local oscillator light source is adjusted by adjusting the emitting-end light source temperature controller and the local oscillator light source temperature controller; the emitting-end light source operating current and the local oscillator light source operating current are adjusted by the electric control box of the emitting-end light source and the electric control box of the local oscillator light source. The above-mentioned process can indirectly adjust the emitting-end wavelength, the local oscillator wavelength, an emitting-end output optical power, and a local oscillator optical power. By establishing a corresponding lookup table for temperature, operating current, wavelength, and output optical power, the wavelength required for communication can be quickly located when the communication is initially established. Furthermore, by setting the temperature monitoring points to increase in sequence and setting the operating current to increase in sequence, the lookup table can further facilitate searching for temperature, operating current, corresponding wavelength, and output optical power.

In one embodiment, as shown in FIG. 8, the process of setting the initial local oscillator wavelength emitted by the local oscillator light source at the receiving end of the optical communication system, and setting the initial local oscillator wavelength to be the same as the initial emission wavelength, includes:
step 802, which includes obtaining the initial emission wavelength of the emitting-end light source.

It can be understood that, when the expected emission wavelength of the emitting-end light source is a preset wavelength, optionally, the initial emission wavelength that is the preset wavelength can be directly obtained. Optionally, the initial emission wavelength of the emitting-end light source received by the receiving end can also be obtained through a spectrometer or the like.
Step 804 includes obtaining an expected local oscillator wavelength of the local oscillator light source according to the initial emission wavelength.

In one embodiment, the expected local oscillator wavelength of the local oscillator light source is set to be the same as the initial emission wavelength.
Step 806 includes searching, according to the expected local oscillator wavelength, a local oscillator light source lookup table to obtain an initial local oscillator light source temperature monitoring point.

Specifically, the local oscillator light source temperature monitoring point corresponding to the wavelength expected to be output by the local oscillator light source can be found through the local oscillator light source lookup table.
Step 808 includes setting a local oscillator light source temperature monitoring point as the initial local oscillator light source temperature monitoring point.

Specifically, the local oscillator light source temperature controller is controlled to adjust the temperature of the local oscillator light source to the local oscillator light source temperature monitoring point corresponding to a wavelength expected to be output by the local oscillator light source, such that the local oscillator light source can output the expected output wavelength.

In one embodiment, when the expected emission wavelength of the emitting-end light source is WaveLen_n, the expected local oscillator wavelength of the local oscillator light source is also WaveLen_n. Then, emitting reference wavelengths TX WaveLen_i and TX WaveLen_(i+1) of the two emitting-end light sources satisfying formula (1) can be found in the emitting-end light source lookup table; similarly, the local oscillator reference wavelengths LO WaveLen_i and LO WaveLen_(i+1) of the two local oscillator light sources satisfying formula (2) can also be found in the local oscillator light source lookup table:

$$Formula ( 1 ) includes : TX WaveLen\_i < WaveLen\_n \leq TX WaveLen\_ ( i + 1 ) , in which i = 1 , 2 , 3 , … , M . \\ Formula ( 2 ) includes : LO WaveLen\_i < WaveLen\_n \leq LO WaveLen\_ ( i + 1 ) , in which i = 1 , 2 , 3 , … , M .$$

Therefore, a fitting algorithm, such as a linear interpolation manner, can be used to obtain an initial emitting-end light source temperature monitoring point and an initial local oscillator light source temperature monitoring point. The temperature of the emitting-end light source is set to the emitting-end light source temperature monitoring point by the emitting-end light source temperature controller, and the temperature of the local oscillator light source is set to the local oscillator light source temperature monitoring point by the local oscillator light source temperature controller, such that the emitting-end light source emits the expected output wavelength and the local oscillator light source emits the expected output wavelength.

Specifically, in one embodiment, the expected emission wavelength of the emitting-end light source is WaveLen_n, and the expected local oscillator wavelength of the local oscillator light source is also WaveLen_n. When looking up WaveLen_n in the emitting-end light source lookup table, i=2 is obtained. That is, for the emitting-end light source, the following can be obtained:

$$TX WaveLen\_ 2 < WaveLen\_n \leq TX WaveLen\_ 3.$$

Optionally, the emitting-end light source lookup table is a linear table. Therefore, for the emitting-end light source, the initial emitting-end light source temperature monitoring point satisfies:

$$TX Thermal Monitor\_ 2 < TX Thermal Monitor\_n \leq TX Thermal$$

### Monitor_3.

When looking up WaveLen_n in the local oscillator light source lookup table, i=4 is obtained. That is, for the local oscillator light source, the following is obtained:

$$LO WaveLen\_ 4 < WaveLen\_n \leq LO WaveLen\_ 5.$$

Optionally, the local oscillator light source lookup table is a linear table. Therefore, for the local oscillator light source, the initial local oscillator light source temperature monitoring point satisfies:

$$LO Thermal Monitor\_ 4 < LO Thermal Monitor\_n \leq LO Thermal Monitor\_ 5.$$

Furthermore, the specific value of the initial emitting-end light source temperature monitoring point and the specific value of the initial local oscillator light source temperature monitoring point can be obtained by linear interpolation.

For the emitting-end light source, the specific value of the initial emitting-end light source temperature monitoring point can be obtained by formula (3) of:

$$TX Thermal Monitor\_n = \frac{TX Thermal Monitor\_ 3 - TX Thermal Monitor\_ 2}{TX WaveLen\_ 3 - TX WaveLen\_ 2} \times ( WaveLen\_n - TX WaveLen\_ 2 ) + TX Thermal Monitor\_ 2 \qquad ( 3 )$$

For the local oscillator light source, the specific value of the initial local oscillator light source temperature monitoring point can be obtained by formula (4) of:

$$LO Thermal Monitor\_n = \frac{LO Thermal Monitor\_ 5 - LO Thermal Monitor\_ 4}{LO WaveLen\_ 5 - LO WaveLen\_ 4} \times ( WaveLen\_n - LO WaveLen\_ 4 ) + LO Thermal Monitor\_ 4 \qquad ( 4 )$$

Therefore, the temperature of the emitting-end light source is set to TX Thermal Monitor_n by the emitting-end light source temperature controller, and the temperature of the local oscillator light source is set to LO Thermal Monitor_n by the local oscillator light source temperature controller, such that the emitting-end light source emits an initial emission wavelength WaveLen_n and the local oscillator light source emits an initial local oscillator wavelength WaveLen_n.

It can be understood that the initial wavelengths of the uplink emitting-end light source and the downlink local oscillator light source are both realized by looking up the lookup table, and the uplink emitting-end light source maintains the temperature monitoring point and the driving current unchanged for a long period, thereby keeping operating conditions basically unchanged and the emission wavelength as stable as possible.

As the working time and ambient temperature change, the wavelength of the uplink emitting-end light source and the wavelength of the downlink local oscillator light source will inevitably drift, and the drift amounts are inconsistent. Therefore, after the emission wavelength emitted by the uplink emitting-end light source is received by the downlink receiving end, the received wavelength will be inconsistent with the local oscillator wavelength emitted by the downlink local oscillator light source. Therefore, the downlink local oscillator wavelength needs to be further adjusted in real time to keep the local oscillator wavelength consistent with the received wavelength.

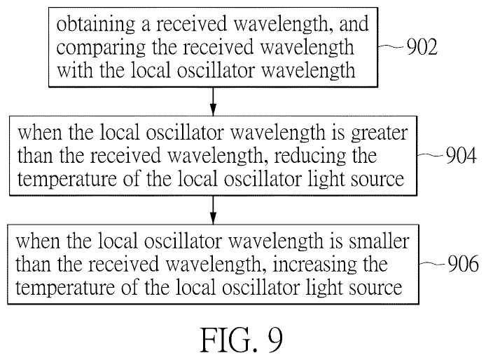

In one embodiment, as shown in FIG. 9, in step 108, adjusting the local oscillator wavelength in real time, so that the wavelength emitted by the local oscillator light source is consistent with the wavelength received by the receiving end, includes:
step 902, which includes obtaining a received wavelength, and comparing the received wavelength with the local oscillator wavelength.
Step 904 includes, when the local oscillator wavelength is greater than the received wavelength, reducing the temperature of the local oscillator light source.
Step 906 includes, when the local oscillator wavelength is smaller than the received wavelength, increasing the temperature of the local oscillator light source.

Specifically, the receiving end processes a received signal to obtain a wavelength difference λ_{RX}−λ_{LO} between the received wavelength λ_{RX} and the local oscillator wavelength λ_{LO} of the local oscillator light source, and the wavelength difference is collected in real time for a long period. Optionally, the wavelength difference is collected in real time for a long period by a microcontroller unit (MCU).

When the wavelength difference λ_{RX}−λ_{LO} is smaller than 0, that is, the local oscillator wavelength is greater than the received wavelength, the MCU controls the local oscillator light source temperature controller to lower the temperature, thereby reducing the operating temperature of the local oscillator light source, such that the local oscillator wavelength λ_{LO} is reduced to the same as the received wavelength λ_{RX}.

When the wavelength difference λ_{RX}−λ_{LO} is greater than 0, that is, the local oscillator wavelength is smaller than the received wavelength, the MCU controls the local oscillator light source temperature controller to increase the temperature, thereby increasing the operating temperature of the local oscillator light source, such that the local oscillator wavelength λ_{LO} is increased to the same as the received wavelength λ_{RX}.

In this embodiment, by adjusting the local oscillator wavelength in real time, a long-term consistency can be maintained between the received wavelength aX received by the receiving end and the emission wavelength of the uplink emitting-end light source under various operating conditions, thereby achieving wavelength locking control.

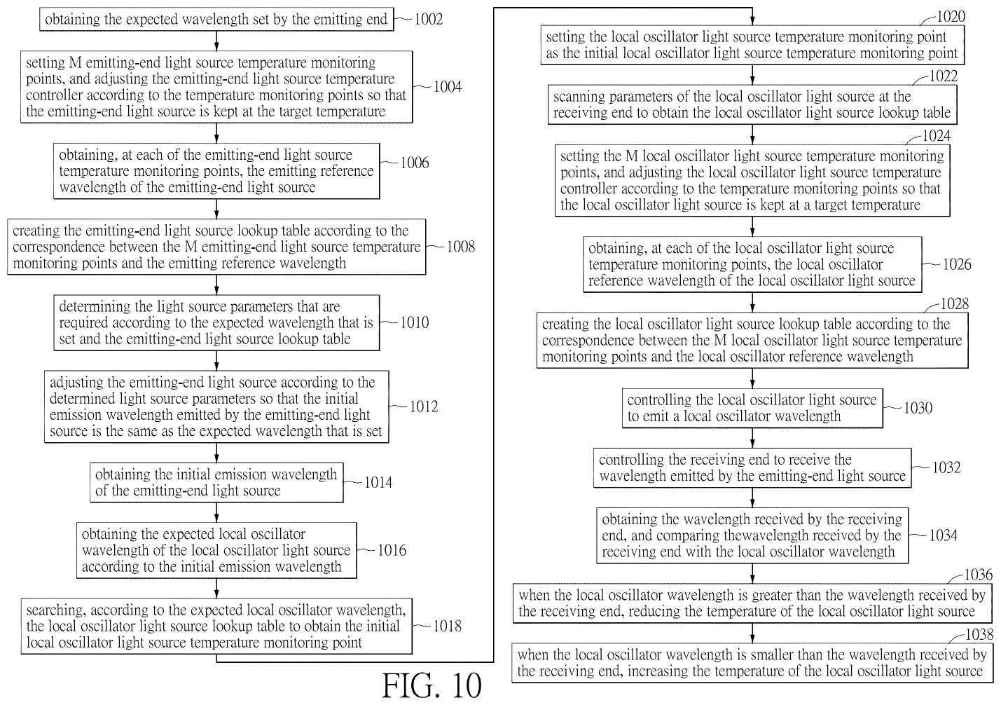

In another embodiment, as shown in FIG. 10, a method for wavelength control in an optical communication system is provided, and includes the following processes:
step 1002, which includes obtaining the expected wavelength set by the emitting end.
Step 1004 includes setting M emitting-end light source temperature monitoring points, and adjusting the emitting-end light source temperature controller according to the temperature monitoring points so that the emitting-end light source is kept at the target temperature.
Step 1006 includes obtaining, at each of the emitting-end light source temperature monitoring points, the emitting reference wavelength of the emitting-end light source.
Step 1008 includes creating the emitting-end light source lookup table according to the correspondence between the M emitting-end light source temperature monitoring points and the emitting reference wavelength.
Step 1010 includes determining the light source parameters that are required according to the expected wavelength that is set and the emitting-end light source lookup table.
Step 1012 includes adjusting the emitting-end light source according to the determined light source parameters so that the initial emission wavelength emitted by the emitting-end light source is the same as the expected wavelength that is set.
Step 1014 includes obtaining the initial emission wavelength of the emitting-end light source.
Step 1016 includes obtaining the expected local oscillator wavelength of the local oscillator light source according to the initial emission wavelength.
Step 1018 includes searching, according to the expected local oscillator wavelength, the local oscillator light source lookup table to obtain the initial local oscillator light source temperature monitoring point.
Step 1020 includes setting the local oscillator light source temperature monitoring point as the initial local oscillator light source temperature monitoring point.
Step 1022 includes scanning parameters of the local oscillator light source at the receiving end to obtain the local oscillator light source lookup table.
Step 1024 includes setting the M local oscillator light source temperature monitoring points, and adjusting the local oscillator light source temperature controller according to the temperature monitoring points so that the local oscillator light source is kept at a target temperature.
Step 1026 includes obtaining, at each of the local oscillator light source temperature monitoring points, the local oscillator reference wavelength of the local oscillator light source.
Step 1028 includes creating the local oscillator light source lookup table according to the correspondence between the M local oscillator light source temperature monitoring points and the local oscillator reference wavelength.
Step 1030 includes controlling the local oscillator light source to emit a local oscillator wavelength.
Step 1032 includes controlling the receiving end to receive the wavelength emitted by the emitting-end light source.
Step 1034 includes obtaining the wavelength received by the receiving end, and comparing the wavelength received by the receiving end with the local oscillator wavelength.
Step 1036 includes, when the local oscillator wavelength is greater than the wavelength received by the receiving end, reducing the temperature of the local oscillator light source.
Step 1038 includes, when the local oscillator wavelength is smaller than the wavelength received by the receiving end, increasing the temperature of the local oscillator light source.

In this embodiment, the emitting-end light source and the local oscillator light source directly use DFB laser light sources, thereby reducing the requirements for laser light sources, and even eliminating the need of a tunable laser having an external cavity, such that the overall volume is small, the degree of integration is high, and the cost is low. Since the emitting-end light source and the local oscillator light source adopt two lasers, the temperature change of each laser will affect the output wavelength of the laser. Therefore, by establishing a one-to-one lookup table between temperature and wavelength, the wavelength required for communication can be quickly located according to the emitting-end light source lookup table and the local oscillator light source lookup table when initially establishing communication. Furthermore, by adjusting the emitting-end light source temperature monitoring point and the local oscillator light source temperature monitoring point, the emitting-end light source and the local oscillator light source are controlled to emit the initial emission wavelength and the initial local oscillator wavelength having the same wavelength, so as to quickly establish communication. Moreover, during the communication process, the received wavelength is compared with the local oscillator wavelength in real time, and the local oscillator wavelength is adjusted to be consistent with the received wavelength, so as to ensure that the receiving end can automatically adjust the local oscillator wavelength, such that the local oscillator wavelength is consistent with the wavelength at the receiving end, allowing the subsequent signal extraction to be more accurate.

It should be understood that, although the various steps in the flowcharts involved in the above-mentioned embodiments are displayed in sequence according to the indication of the arrows, these steps are not necessarily executed in sequence according to the order indicated by the arrows. Unless there is a clear explanation in the detailed description, the execution of these steps is not strictly limited to an order, and these steps can be executed in other orders. Furthermore, at least a part of the steps in the flowcharts involved in the above-mentioned embodiments can include multiple steps or multiple stages, and these steps or stages are not necessarily executed at the same time, but can be executed at different times, and the order of execution of these steps or stages is not necessarily carried out in sequence, but can be executed in turn or alternately with other steps or at least a part of the steps or stages in other steps.

Based on the same concept, the embodiment of the present application further provides an apparatus for wavelength control for implementing the method for wavelength control as described above. Since the implementation provided by the apparatus to address the issue is similar to the implementation solution as described in the above-mentioned method, the specific limitations in one or more embodiments of the apparatus for wavelength control provided below can refer to the limitations of the method for wavelength control as mentioned above, and will not be reiterated herein.

In one embodiment, as shown in FIG. 11, an apparatus for wavelength control in an optical communication system is provided, and the apparatus includes: an emitting-end light source setting module 1102, a local oscillator light source control module 1104, a receiving-end control module 1106, and a wavelength adjustment module 1108, in which:

The emitting-end light source setting module 1102 is used to set the initial emission wavelength emitted by the emitting-end light source in the optical communication system; the local oscillator light source control module 1104 is used to control the local oscillator light source at the receiving end in the optical communication system to emit the local oscillator wavelength; the receiving-end control module 1106 is used to control the receiving end to receive the wavelength emitted by the emitting-end light source; the wavelength adjustment module 1108 is used to adjust the wavelength emitted by the local oscillator light source in real time, so that the wavelength emitted by the local oscillator light source is consistent with the wavelength received by the receiving end.

In one embodiment, the apparatus for wavelength control in the optical communication system further includes a local oscillator initial setting module for setting the initial local oscillator wavelength emitted by the local oscillator light source at the receiving end of the optical communication system, and setting the initial local oscillator wavelength to be the same as the initial emission wavelength.

In one embodiment, the emitting-end light source setting module 1102 is further used to obtain the expected wavelength set by the emitting end and the emitting-end light source lookup table, determine the required light source parameters according to the expected wavelength that is set and the emitting-end light source lookup table, and adjust the emitting-end light source according to the determined light source parameters, so that the initial emission wavelength emitted by the emitting-end light source is the same as the expected wavelength that is set.

In one embodiment, the local oscillator light source control module 1104 is further used to scan the parameters of the local oscillator light source at the receiving end, obtain the local oscillator light source lookup table, and control the local oscillator light source to emit the local oscillator wavelength.

In one embodiment, the emitting-end light source setting module 1102 is further used to set the M emitting-end light source temperature monitoring points, and adjust the emitting-end light source temperature controller according to the temperature monitoring points so that the emitting-end light source is kept at the target temperature; obtain, at each of the emitting-end light source temperature monitoring points, the emitting reference wavelength of the emitting-end light source; and create the emitting-end light source lookup table according to the correspondence between the M emitting-end light source temperature monitoring points and the emitting reference wavelength.

In one embodiment, the local oscillator light source control module 1104 is further used to set the M local oscillator light source temperature monitoring points, adjust the local oscillator light source temperature controller according to the temperature monitoring points so that the local oscillator light source is kept at the target temperature; obtain, at each of the local oscillator light source temperature monitoring points, the local oscillator reference wavelength of the local oscillator light source; and create the local oscillator light source lookup table according to the correspondence between the M local oscillator light source temperature monitoring points and the local oscillator reference wavelength.

In one embodiment, the emitting-end light source setting module 1102 is further used to set the M emitting-end light source temperature monitoring points, and adjust the emitting-end light source temperature controller according to the temperature monitoring points so that the emitting-end light source is kept at the target temperature; set, at each of the emitting-end light source temperature monitoring points, N emitting-end light source operating currents; obtain, at each of the emitting-end light source operating currents, the emitting reference output optical power and the emitting reference wavelength of the emitting-end light source; and create the emitting-end light source lookup table according to the correspondence between the M emitting-end light source temperature monitoring points, the N emitting-end light source operating currents, and the emitting reference output optical power and the emitting reference wavelength of the emitting-end light source.

In one embodiment, the local oscillator light source control module 1104 is further used to set the M local oscillator light source temperature monitoring points, and adjust the local oscillator light source temperature controller according to the temperature monitoring points so that the local oscillator light source is kept at the target temperature; set, at each of the local oscillator light source temperature monitoring points, N local oscillator light source operating currents; obtain, at each of the local oscillator light source operating currents, the local oscillator reference output optical power and the local oscillator reference wavelength of the local oscillator light source; and create the local oscillator light source lookup table according to the correspondence between the M local oscillator light source temperature monitoring points, the N local oscillator light source operating currents, the local oscillator reference output optical power, and the local oscillator reference wavelength.

In one embodiment, the local oscillator initial setting module is further used to obtain the initial emission wavelength of the emitting-end light source; obtain the expected local oscillator wavelength of the local oscillator light source according to the initial emission wavelength; search, according to the expected local oscillator wavelength, the local oscillator light source lookup table to obtain the initial local oscillator light source temperature monitoring point; and set the local oscillator light source temperature monitoring point as the initial local oscillator light source temperature monitoring point.

In one embodiment, the wavelength adjustment module 1108 is further used to obtain the wavelength received by the receiving end, and compare the wavelength received by the receiving end with the local oscillator wavelength; when the local oscillator wavelength is greater than the wavelength received by the receiving end, reduce the temperature of the local oscillator light source; when the local oscillator wavelength is smaller than the wavelength received by the receiving end, increase the temperature of the local oscillator light source.

Modules of the abovementioned apparatus for wavelength control can be implemented in whole or in part by software, hardware, or a combination thereof. Each of the modules can be embedded in or independent of a processor in a computer device in the form of hardware, or can be stored in a memory in a computer device in the form of software, such that the processor can call and execute the operations corresponding to each of the modules.

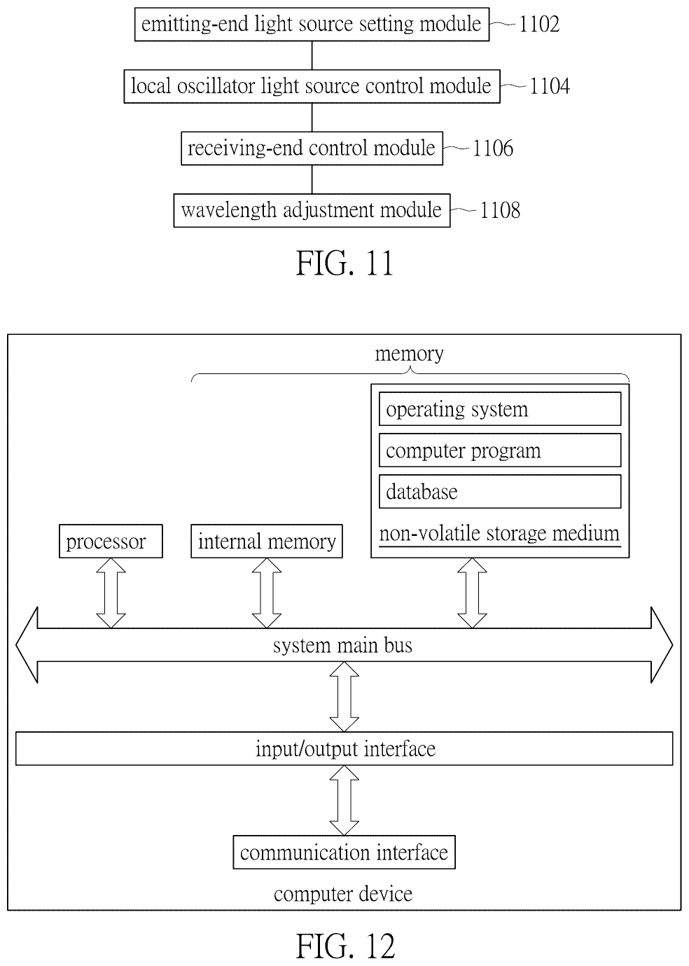

In one embodiment, a computer device is provided. The computer device may be a server, and its internal structure diagram may be as shown in FIG. 12. The computer device includes a processor, a memory, an input/output interface (hereinafter referred to as I/O), and a communication interface. The processor, the memory, and the input/output interface are connected together through a system main bus, and the communication interface is connected to the system main bus through the input/output interface. The processor of the computer device is used to provide computing and control capabilities. The memory of the computer device includes a non-volatile storage medium and an internal memory. The non-volatile storage medium stores an operating system, a computer program, and a database. The internal memory provides an environment for the operation of the operating system and the computer program in the non-volatile storage medium. The database of the computer device is used to store data such as parameters of the emitting-end light source, the emitting-end light source lookup table, parameters of the local oscillator light source, and the local oscillator light source lookup table. The input/output interface of the computer device is used to exchange information between the processor and an external device. The communication interface of the computer device is used to communicate with an external terminal through a network connection. When the computer program is executed by the processor, the method for wavelength control is implemented.

Those skilled in the art can understand that the structure shown in FIG. 12 is only a block diagram of a partial structure related to the solution of the present application, and does not constitute a limitation on the computer device to which the solution of the present application is applied. The specific computer device may include more or fewer components than those shown in the figure, or combine certain components, or have a different arrangement of components.

In one embodiment, a computer device is further provided, which includes a memory and a processor. A computer program is stored in the memory, and the processor implements the steps in the above-mentioned embodiments of the method when executing the computer program.

In one embodiment, a computer-readable storage medium is provided, on which a computer program is stored. When the computer program is executed by a processor, the steps in the abovementioned embodiments of the method are implemented.

In one embodiment, a computer program product is provided, which includes a computer program. When the computer program is executed by a processor, the steps in the abovementioned embodiments of the method are implemented.

It should be noted that the user information (including but not limited to user device information, user personal information, etc.) and data (including but not limited to data used for analysis, stored data, displayed data, etc.) involved in this application are all information and data authorized by the user or fully authorized by all parties, and the collection, use, and processing of relevant data need to comply with relevant laws, regulations, and standards of relevant countries and regions.

A skilled person in the art can understand that, all or part of the processes in the abovementioned embodiment method can be completed by instructing the relevant hardware through a computer program, and the computer program can be stored in a non-volatile computer-readable storage medium. When the computer program is executed, it can include the processes of the embodiments of the abovementioned methods. Here, any reference to the memory, database, or other medium used in the embodiments provided in the present application can include at least one of non-volatile and volatile memory. Non-volatile memory can include read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM), phase change memory (PCM), graphene memory, etc. Volatile memory can include random access memory (RAM) or external high-speed cache memory, etc. As an illustration and not limitation, RAM can be in various forms, such as static random access memory (SRAM) or dynamic random access memory (DRAM). The database involved in each of the embodiments provided in this application may include at least one of a relational database and a non-relational database. The non-relational database may include such as a distributed database based on blockchains, but are not limited thereto. The processor involved in each of the embodiments provided in this application may be such as a general-purpose processor, a central processing unit, a graphics processor, a digital signal processor, a programmable logic unit, a data processing logic unit based on quantum computing, but is not limited thereto.

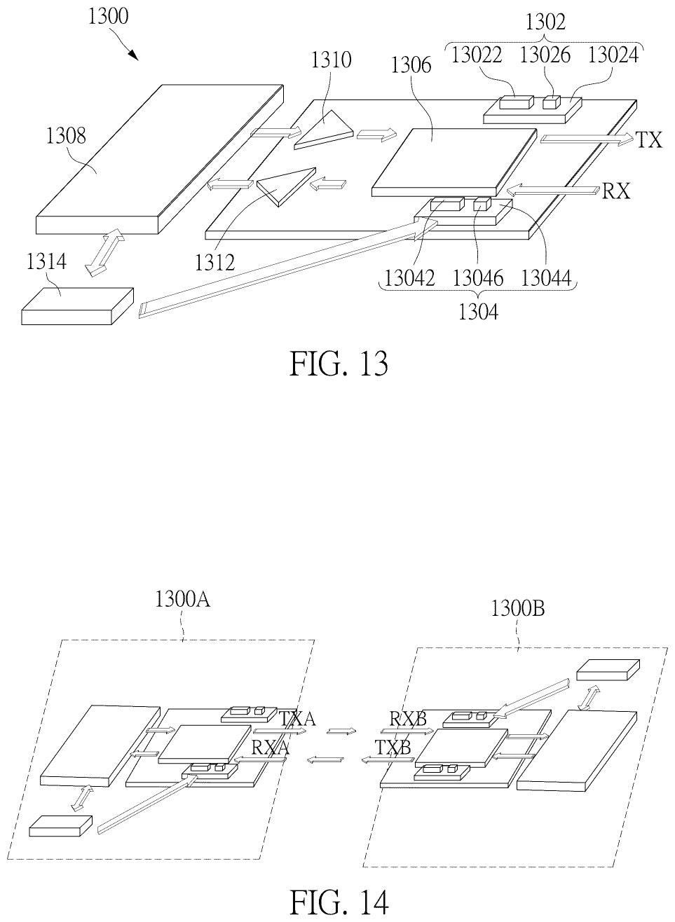

Reference is further made to FIG. 13, and FIG. 13 shows a schematic diagram of the structure of a coherent optical communication apparatus 1300 in one embodiment of the present disclosure. A coherent optical communication apparatus provided in one embodiment of the present disclosure includes an emitting-end light source module 1302 used to emit emission light, a local oscillator light source module 1304 used to emit local oscillator light, a data processing module 1308 including a data processing unit used to modulate an electrical signal and output the modulated electrical signal to a photonic integrated circuit 1306 and/or process an electrical signal to be demodulated received from the photonic integrated circuit 1306; and the apparatus for wavelength control in any of the abovementioned embodiments used to implement the method for wavelength control; the photonic integrated circuit 1306 is used for receiving the modulated electrical signal from the data processing module or outputting the electrical signal to be demodulated to the data processing apparatus, including: a coherent modulator used to modulate the emission light through the modulated electrical signal to form an emission light signal, and emit the emission light signal from the emitting end; a coherent receiver used to receive the optical signal from the receiving end and convert the optical signal into an electrical signal.

Optionally, in a preprocessing stage, the apparatus for wavelength control of the data processing module 1308 can obtain the emitting-end light source lookup table by scanning the emitting-end light source module 1302 to emit the emitted light; and obtain the local oscillator light source lookup table by scanning the local oscillator light emitted by the local oscillator light source module 1304. Furthermore, by setting the initial emission wavelength and the initial local oscillator wavelength to be the same, the coherent optical communication apparatus 1300 has a small wavelength difference when it is started, so as to quickly establish normal coherent communication.

Optionally, the data processing module 1308 may be a digital signal processor (DSP). The data processing module 1308 outputs the modulated electrical signal to the photonic integrated circuit 1306 (PIC). The emission light emitted by the emitting-end light source module 1302 is also input to the photonic integrated circuit 1306. The photonic integrated circuit 1306 performs electrical-optical conversion on the modulated electrical signal, loads the electrical signal into the optical signal of the emission light input by the emitting-end light source module 1302 through a coherent modulator, obtains an emission light signal modulated by the modulated electrical signal, and outputs the modulated emission light signal from an emitting end TX. It can be understood that the optical signal may be an optical signal that carries information. At this time, the coherent optical communication apparatus 1300 serves as an uplink integrated coherent device.

When the coherent optical communication apparatus 1300 is used as a downlink integrated coherent device, the receiving end RX receives an optical signal, and optionally, the optical signal is an optical signal that carries information. The local oscillator light source module 1304 emits local oscillator light and inputs the local oscillator light into the photonic integrated circuit 1306. In the photonic integrated circuit 1306, the coherent receiver receives the optical signal from the receiving end, and performs interference demodulation between the local oscillator light and the received optical signal.

In one embodiment, the transmission formula of the optical signal received by the receiving end RX is: Eₛ(t)=S(t)e^{j(ω}^{ₛ}^{t+θ}^{ₛ₎}, and its corresponding intensity is: Iₛ(t)=|S(t)|², in which:
S(t) is the amplitude of the received optical signal.
ωₛ is the angular frequency of the received optical signal, and the relationship between the angular frequency ωₛ, the wavelength λₛ, and the speed of light c is: ωₛ=2πc/λₛ).
θₛ is the initial phase of the received optical signal.
j is the imaginary unit.

The transmission formula of the local oscillator light is E₁(t)=L(t)e^{j(ω}^{₁}^{t+θ}^{₁₎}, and its corresponding intensity is: I₁(t)=|L(t)|², in which:
L(t) is the amplitude of the local oscillator light.
ω₁ is the angular frequency of the local oscillator light, and the relationship between the angular frequency ω₁, the wavelength λ₁, and the speed of light c is: ω₁=2πc/λ₁).
θ₁ is the initial phase of the local oscillator light.
j is the imaginary unit.

The received optical signal and the local oscillator light are coherently demodulated through a coherent receiver. Specifically, the received optical signal and the local oscillator light are interfered and mixed. Therefore, the transmission formulas of the output optical signal in a single polarization state after mixing are: E₁(t)+Eₛ(t), E₁(t)−Eₛ(t), E₁(t)+jEₛ(t), and E₁(t)−jEₛ(t).

The above-mentioned output optical signal undergoes photoelectric conversion by a photodetector in a coherent modulator. Optionally, the photodetector can be a differential photodiode (PD). The electrical signals shown in formulas (5) and (6) below can be obtained respectively:

$$Formula ( 5 ) includes : {\vert {E}_{l} ( t ) + {E}_{s} ( t ) \vert}^{2} - {\vert {E}_{l} ( t ) - {E}_{s} ( t ) \vert}^{2} = 4 S ( t ) L ( t ) cos [ ( {ω}_{s} - {ω}_{l} ) t + ( {θ}_{s} - {θ}_{l} ) ] . \\ Formula ( 6 ) includes : {\vert {E}_{l} ( t ) + {jE}_{s} ( t ) \vert}^{2} - {\vert {E}_{l} ( t ) - {jE}_{s} ( t ) \vert}^{2} = 4 S ( t ) l ( t ) sin [ ( {ω}_{s} - {ω}_{l} ) t + ( {θ}_{s} - {θ}_{l} ) ] .$$

Thus, the data processing module 1308 receives the electrical signal to be demodulated from the photonic integrated circuit 1306, and analyzes and processes the signal to be demodulated to obtain: S(t)L(t)e^{j[(ω}^{ₛ}^{-ω}^{₁}^{)t+(θ}^{ₛ}^{-θ}^{₁}^{)]}, and after frequency synchronization detection and low-pass filtering, the angular frequency difference ωₛ−ω₁ between the received signal and the local oscillator light can be obtained, and the wavelength difference λₛ−λ₁ between the received signal and the local oscillator light can be obtained by conversion. Thus, the values of the wavelength deviation error signals at the emitting end and the receiving end can be known through the monitoring and reporting of the data processing module 1308.

Optionally, the coherent optical communication apparatus 1300 further includes a driver 1310. The data processing module 1308 outputs a modulated electrical signal, the modulated electrical signal is amplified after passing through the driver 1310, and the amplified electrical signal is input into the photonic integrated circuit 1306.

Optionally, the coherent optical communication apparatus 1300 further includes a transimpedance amplifier (TIA) 1312. The receiving end receives an optical signal that carries information, and coherently demodulates the received optical signal with the local oscillator optical signal to obtain a demodulated optical signal, and converts the optical signal into an electrical signal through a photodetector. The converted electrical signal is input to the transimpedance amplifier 1312, and the transimpedance amplifier 1312 converts a current signal into a voltage signal, and at the same time linearly amplifies and inputs the signals into the data processing module 1308.

In one embodiment, the emitting-end light source module 1302 includes: an emitting-end light source 13022 for emitting the emission light having an emission wavelength; an emitting-end light source temperature controller 13024 for controlling the temperature of the emitting-end light source; and an emitting-end light source temperature monitor 13026 for monitoring the temperature of the emitting-end light source.

In one embodiment, the local oscillator light source module includes: a local oscillator light source 13042 for emitting local oscillator light having a local oscillator wavelength; a local oscillator light source temperature controller 13044 for controlling the temperature of the local oscillator light source; and a local oscillator light source temperature monitor 13046 for monitoring the temperature of the local oscillator light source.

Referring further to FIG. 13, the change of the light source temperature will affect the change of the light source output wavelength. That is, when the light source temperature is high, the output wavelength is long; and when the light source temperature is low, the output wavelength is short. Therefore, the output wavelength is controlled by temperature control. The emitting-end light source temperature controller 13024 is set for the emitting-end light source 13022 to perform temperature control on the emitting-end light source 13022, and an emitting-end light source temperature monitor 13026 monitors the operating temperature of the emitting-end light source 13022. When the parameters of the emitting-end light source 13022 are scanned in the preprocessing stage, the emitting-end light source lookup table can be obtained, and when the communication is initially established, the initial emission wavelength of the emitting-end light source 13022 can be obtained according to the lookup table.

The local oscillator light source temperature controller 13044 is provided for the local oscillator light source 13042 to control the temperature of the local oscillator light source 13042. At this time, the local oscillator light source temperature monitor 13046 monitors the operating temperature of the local oscillator light source. When the parameters of the local oscillator light source 13042 are scanned in the preprocessing stage, the local oscillator light source lookup table can be obtained, and when the communication is initially established, the initial local oscillator wavelength of the local oscillator light source 13042 can be obtained according to the lookup table, so that the initial local oscillator wavelength is consistent with the initial emission wavelength.

Optionally, the emitting-end light source temperature controller 13024 and the local oscillator light source temperature controller 13044 may be a heating type temperature controller or a thermo electric cooler (TEC) temperature controller; and the emitting-end light source temperature monitor 13026 and the local oscillator light source temperature monitor 13066 may be thermistors.

Optionally, the coherent optical communication apparatus 1300 further includes a microcontroller unit (MCU) 1314. Temperature signals detected by the emitting-end light source temperature monitor 13026 and the local oscillator light source temperature monitor 13066 are converted into digital signals by an analog-to-digital conversion chip and then collected by the microcontroller unit 1314, and the obtained emitting-end light source lookup table and local oscillator light source lookup table are stored in the microcontroller unit 1314.

Referring to FIG. 14, FIG. 14 is a schematic diagram of the structure of two integrated coherent apparatuses 1300 transmitting with each other according to one embodiment of the present disclosure.

A first emitting end TXA of a first integrated coherent device 1300A transmits a modulated optical signal to a second receiving end RXB of a second integrated coherent device 1300B; and a second emitting end TXB of the second integrated coherent device 1300B transmits a modulated optical signal to a first receiving end RXA of the first integrated coherent device 1300A or the receiving end of another integrated coherent device.

In the preprocessing stage, the temperature of a first emitting-end light source is adjusted by a first emitting-end light source temperature controller of the first integrated coherent device 1300A, so as to formulate the emission wavelength of the first emitting-end light source at different temperature monitoring points, and obtain a first emitting-end light source lookup table; the temperature of a first local oscillator light source is adjusted by a first local oscillator light source temperature controller of the first integrated coherent device 1300A, so as to formulate the local oscillator wavelength of the first local oscillator light source at different temperature monitoring points, and obtain a first local oscillator light source lookup table; the temperature signals detected by a first emitting-end light source temperature monitor and a first local oscillator light source temperature monitor are converted into digital signals through the analog-to-digital conversion chip and then collected by a first microcontroller unit, and the obtained first emitting-end light source lookup table and the first local oscillator light source lookup table are stored in the first microcontroller unit.

Furthermore, in the preprocessing stage, the temperature of a second emitting-end light source is adjusted by a second emitting-end light source temperature controller of the second integrated coherent device 1300B, so as to formulate the emission wavelength of the second emitting-end light source under different temperature monitoring points, and obtain a second emitting-end light source lookup table; the temperature of a second local oscillator light source is adjusted by a second local oscillator light source temperature controller of the second integrated coherent device 1300B, so as to formulate the local oscillator wavelength of the second local oscillator light source under different temperature monitoring points, and obtain a second local oscillator light source lookup table; the temperature signals detected by a second emitting-end light source temperature monitor and a second local oscillator light source temperature monitor are converted into digital signals through the analog-to-digital conversion chip and then collected by a second microcontroller unit, and the obtained second emitting-end light source lookup table and the second local oscillator light source lookup table are stored in the second microcontroller unit.

It can be understood that the first emitting-end light source lookup table, the first local oscillator light source lookup table, the second emitting-end light source lookup table, and the second local oscillator light source lookup table can further include data on the light source operating current and the light source output optical power, details thereof are as described in the aforementioned embodiments, and will not be reiterated herein.

During operation, an operating temperature of the light source will affect the output wavelength: when the operating temperature increases, the wavelength increases; conversely, the wavelength decreases. In addition, when a driving current of the light source increases, the power loss will increase, causing the operating temperature to increase, thus causing the increase of wavelength.

When the coherent optical module operates normally, a first data processing module processes a beat frequency signal to determine the difference between the wavelength of the first local oscillator light source and the wavelength of the optical signal received by the first receiving end RXA, that is, the wavelength of the optical signal emitted by the second emitting end TXB, and further fine-tunes the heating amount of the first local oscillator light source temperature controller of the first local oscillator light source, thereby ensuring the wavelength consistency of the emission wavelength and the received wavelength.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A method for wavelength control in an optical communication system, characterized by comprising:
setting an initial emission wavelength emitted by an emitting-end light source in the optical communication system;
controlling a local oscillator light source at a receiving end in the optical communication system to emit a local oscillator wavelength;
controlling the receiving end to receive the wavelength emitted by the emitting-end light source;
adjusting the wavelength emitted by the local oscillator light source in real time, so that the wavelength emitted by the local oscillator light source is consistent with the wavelength received by the receiving end.

2. The method according to claim 1, characterized in that, before controlling the local oscillator light source at the receiving end in the optical communication system to emit the local oscillator wavelength, the method comprises:
setting an initial local oscillator wavelength emitted by the local oscillator light source at the receiving end in the optical communication system, so that the initial local oscillator wavelength is set to be the same as the initial emission wavelength.

3. The method according to claim 1, characterized in that, the process of setting the initial emission wavelength emitted by the emitting-end light source of the optical communication system includes:
obtaining an expected wavelength that is set at an emitting end and an emitting-end light source lookup table;
determining light source parameters that are required according to the expected wavelength that is set and the emitting-end light source lookup table;
adjusting the emitting-end light source according to the determined light source parameters so that the initial emission wavelength emitted by the emitting-end light source is the same as the expected wavelength that is set.

4. The method according to claim 1, characterized in that, the process of controlling the local oscillator light source at the receiving end in the optical communication system to emit the local oscillator wavelength includes:
scanning parameters of the local oscillator light source at the receiving end to obtain a local oscillator light source lookup table;
controlling the local oscillator light source to emit the local oscillator wavelength.

5. The method according to claim 3, characterized in that, the process of obtaining the emitting-end light source lookup table includes:
setting M emitting-end light source temperature monitoring points, and adjusting an emitting-end light source temperature controller according to the temperature monitoring points so that the emitting-end light source is kept at a target temperature;
obtaining, at each of the emitting-end light source temperature monitoring points, an emitting reference wavelength of the emitting-end light source;
creating an emitting-end light source lookup table according to the correspondence between the M emitting-end light source temperature monitoring points and the emitting reference wavelength.

6. The method according to claim 4, characterized in that, the process of obtaining the local oscillator light source lookup table includes:
setting M local oscillator light source temperature monitoring points, and adjusting a local oscillator light source temperature controller according to the temperature monitoring points so that the local oscillator light source is kept at a target temperature;
obtaining, at each of the local oscillator light source temperature monitoring points, a local oscillator reference wavelength of the local oscillator light source; and
creating the local oscillator light source lookup table according to the correspondence between the M local oscillator light source temperature monitoring points and the local oscillator reference wavelength.

7. The method according to claim 3, characterized in that, the process of obtaining the emitting-end light source lookup table includes:
setting M emitting-end light source temperature monitoring points, and adjusting an emitting-end light source temperature controller according to the temperature monitoring points so that the emitting-end light source is kept at a target temperature;
setting, at each of the emitting-end light source temperature monitoring points, N emitting-end light source operating currents;
obtaining, at each of the emitting-end light source operating currents, an emitting reference output optical power and an emitting reference wavelength of the emitting-end light source;
creating an emitting-end light source lookup table according to the correspondence between the M emitting-end light source temperature monitoring points, the N emitting-end light source operating currents, and the emitting reference output optical power and the emitting reference wavelength of the emitting-end light source.

8. The method according to claim 6, characterized in that, the process of obtaining the local oscillator light source lookup table includes:
setting the M local oscillator light source temperature monitoring points, and adjusting the local oscillator light source temperature controller according to the temperature monitoring points so that the local oscillator light source is kept at a target temperature;
setting, at each of the local oscillator light source temperature monitoring points, N local oscillator light source operating currents;
obtaining, at each of the local oscillator light source operating currents, a local oscillator reference output optical power and the local oscillator reference wavelength of the local oscillator light source;
creating the local oscillator light source lookup table according to the correspondence between the M local oscillator light source temperature monitoring points, the N local oscillator light source operating currents, the local oscillator reference output optical power, and the local oscillator reference wavelength.

9. The method according to claim 2, characterized in that, the process of setting the initial local oscillator wavelength emitted by the local oscillator light source at the receiving end in the optical communication system, so that the initial local oscillator wavelength is set to be the same as the initial emission wavelength includes:
obtaining the initial emission wavelength of the emitting-end light source;
obtaining an expected local oscillator wavelength of the local oscillator light source according to the initial emission wavelength;
searching, according to the expected local oscillator wavelength, a local oscillator light source lookup table to obtain an initial local oscillator light source temperature monitoring point;
setting a local oscillator light source temperature monitoring point as the initial local oscillator light source temperature monitoring point.

10. The method according to claim 1, characterized in that, the process of adjusting the local oscillator wavelength in real time, so that the wavelength emitted by the local oscillator light source is consistent with the wavelength received by the receiving end includes:
obtaining the wavelength received by the receiving end, and comparing the wavelength received by the receiving end with the local oscillator wavelength;
when the local oscillator wavelength is greater than the wavelength received by the receiving end, reducing the temperature of the local oscillator light source;
when the local oscillator wavelength is smaller than the wavelength received by the receiving end, increasing the temperature of the local oscillator light source.

11. An apparatus for wavelength control in an optical communication system, characterized in that, the apparatus comprising:
an emitting-end light source setting module used to set an initial emission wavelength emitted by the emitting-end light source in the optical communication system;
a local oscillator light source control module used to control the local oscillator light source at a receiving end in the optical communication system to emit a local oscillator wavelength;
a receiving-end control module used to control the receiving end to receive the wavelength emitted by the emitting-end light source;
a wavelength adjustment module used to adjust the wavelength emitted by the local oscillator light source in real time, so that the wavelength emitted by the local oscillator light source is consistent with the wavelength received by the receiving end.

12. A computer-readable storage medium having a computer program stored thereon, characterized in that, the computer program implements the processes of the method according to claim 1 when executed by a processor.

13. A computer program product, characterized by comprising a computer program, wherein, when the computer program is executed by a processor, the processes of the method according to claim 1 are implemented.

14. A coherent optical communication apparatus, characterized by comprising:
an emitting-end light source module used to emit emission light;
a local oscillator light source module used to emit local oscillator light;
a data processing module, including:
a data processing unit used to modulate an electrical signal and output the modulated electrical signal to a photonic integrated circuit and/or process an electrical signal to be demodulated received from the photonic integrated circuit;
and the apparatus for wavelength control in the optical communication system as claimed in claim 11, used to implement a method for wavelength control;
the photonic integrated circuit used for receiving the modulated electrical signal from the data processing module or outputting the electrical signal to be demodulated to a data processing apparatus, including:
a coherent modulator used to modulate the emission light through the modulated electrical signal to form an emission light signal, and emit the emission light signal from an emitting end;
a coherent receiver used to receive an optical signal from the receiving end and convert the optical signal into an electrical signal.
